(19) United States
(12) Patent Application Publication
(10) Pub. No.: US 2020/0180189 A1
(43) Pub. Date: Jun. 11, 2020

(54) MOBILE VULCANIZING PRESS

(71) Applicant: VULCTECH GMBH, Atdorf (DE)

(72) Inventor: Andreas KNOTHE, Duisburg (DE)

(73) Assignee: VULCTECH GMBH, Altdorf (DE)

(21) Appl. No.: 16/092,416

(22) PCT Filed: Apr. 10, 2017
(86) PCT No.: PCT/EP2017/058521

§ 371 Date: Oct. 9, 2018

(30) Foreign Application Priority Data
Apr. 8, 2016 (DE) 10 2016 205 942.4

(51) Int. Cl. B29C 33/20

(52) U.S. Cl. CPC B29C 33/202; B29L 2029/00; B29C 2033/207

(57) ABSTRACT

A mobile vulcanizing press including a bottom box and a top box, which can be arranged one above the other with material to be vulcanized in between. The bottom box and/or the top box has/have at least one first bolt receiving section, in which a tension bolt can be pivotally located and at least one detent point is located on the bottom box or the top box, such that a detent means of the tension bolt can engage in the at least one detent point in at least one predetermined pivoting position of the tension bolt.

The present invention relates to a mobile vulcanizing press. This has in particular the technical advantage that it is even more compact and easier to handle, such that the mobile vulcanizing press presented herein is even more suitable for mobile applications and tailored thereto.

Known vulcanizing presses usually have heatable plates (heating plates), which are arranged above and beneath a product to be vulcanized. The product to be vulcanized can be for example a conveyor belt for use in surface mining. The heating plates generate the temperature for carrying out the vulcanization. Known vulcanizing presses have a lower box and an upper box, in which, inter alia, the heating plates are integrated. During the vulcanizing process, the lower and the upper box are connected together by means of a mechanical securing means. Such a securing means can be produced for example by connecting the two boxes by means of a metal clamp (see DE 10 2014 112 296 A1) or by means of (connecting or) tension bolts.

The tension bolts of known vulcanizing presses are fastened optionally in a pivotable manner to the lower box. However, a drawback with the known solutions is that the tension bolts can be removed entirely from the lower box only with difficulty and using tools; however, in the construction of mobile vulcanizing presses, the removal of the securing bolts is quite frequently necessary in order for it to be possible to use the available installation space to the best possible extent. For example, it may be useful, when there is little installation space for the purpose of a structure that has as little complexity as possible, to have the possibility of being able to connect the tension bolts to the lower box only after the rest of the components have been assembled, in order that the tension bolts do not take up additional installation space during construction.

Furthermore, the pivoting range, i.e. the angular range through which it is possible to pivot, of the tension bolts of known vulcanizing presses is set, inter alia, via a securing pin, which is secured by means of splints or the like. The securing pin then lies like “a barrier” in the pivoting radius of the tension bolt and defines the maximum or minimum of the pivoting range. When the tension bolt has been deflected/pivoted to such an extent that it comes into contact with the securing pin, the securing pin retains the tension bolt in this one pivoted position. The tension bolt can then not be pivoted further, as can be useful during assembly, since the tension bolts mounted on the lower box do not then have to be additionally secured or held in position. However, it is a drawback of this known securing means that any change in the pivoting range is possible only with additional tools and further assembly effort, since the splints, the securing pin and the like have to be released for every change; this is inconvenient in daily use, however, since the setup times are extended and the pivoting range which determines the necessary space requirement, laterally or in a longitudinal direction, of the mobile vulcanizing press, cannot be adapted to the available installation space with little effort and without additional tools. The “locked” pivoted position, in which the tension bolt is held by the securing pin, is likewise variable only with additional effort and tools, since, to this end too, the splints, the securing pin etc. have to be released and fastened anew.

Furthermore, in known vulcanizing presses, the upper box is provided with U-shaped cutouts in the housing of the upper box itself, into which cutouts a tension bolt can be introduced. Nuts or the like, which are tightened against the upper surface of the upper box, secure the tension bolt when it is engaged with the U-shaped cutout. However, a drawback here is that, on account of their construction, the nuts and the tension bolts project beyond the upper surface of the upper box, and so the known vulcanizing presses, with regard to mobile use and the frequently only limited installation space, have a relatively large structure. It is also noted that the use of clamps, for example instead of tension bolts, can increase the dimensions of the vulcanizing press in a lateral direction.

Therefore, there is a need for a vulcanizing press which, in terms of handleability and required installation space, is tailored even more systematically to mobile applications, and which is thus particularly suitable for mobile use.

The object is achieved by the invention as per the independent claims. Further preferred developments of the invention are described in the dependent claims.

According to the invention, a securing means for a mobile vulcanizing press can have a tension bolt, which can have an external thread at one of its two axial ends, and at its opposite axial end a latching means can be arranged, preferably in a releasable manner. Furthermore, the tension bolt can have a through-bore, which is arranged between the two axial ends of the tension bolt and the axis of which can be arranged perpendicularly to that of the tension bolt. The position of the latching means or of a latching portion can be elastically variable relative to the axial end of the tension bolt. In other words, a length by which the latching means or a latching portion thereof projects beyond the axial end of the tension bolt can be elastically variable.

A mobile vulcanizing press according to the invention can have a lower box and an upper box. The two boxes can be arranged one on top of the other in a flush manner. Material to be vulcanized can be arranged between the two boxes. Furthermore, at least two preferably above-described securing means/tension bolts for releasably connecting or locking the upper box and the lower box can be provided, wherein in each case at least one can be arranged at one end of the mobile vulcanizing press. The lower box and/or the upper box, preferably the lower box, can have at least one first bolt receptacle on which the tension bolt is arrangeable in a pivotable and particularly preferably releasable manner. Furthermore, at least one latching point can be arranged on the lower box or the upper box such that the latching means of the tension bolt can latch in the at least one latching point in at least one predefined pivoted position of the tension bolt. At this point, it is noted that the invention is primarily described in the following text such that the first bolt receptacle is arranged on the lower box and an optional second bolt receptacle is arranged on the upper box. This disposition is only one example, however, and it can also be reversed, or it is possible for both first and second bolt receptacles to be arranged on each of the lower and upper boxes.

In a technically advantageous manner, the tension bolt can be arranged in a pivotable manner on the mobile vulcanizing press according to the invention, wherein mobile vulcanizing press can provide predefined or predefinable latching positions. Specifically, the invention makes it possible for the latching means to be able to be brought into latching engagement with a corresponding latching point, in that the tension bolt is pivoted on the mobile vulcanizing press until the abovementioned latching engagement occurs. The elastic force of the latching portion then retains the tension bolt in the latching position or the pivoted position, such that the vulcanizing press can be moved, for example, without the tension bolts mounted thereon having to be additionally secured or retained. This considerably improves the handling of the mobile vulcanizing press, since it is a basic requirement of mobile applications that the vulcanizing press be able to be moved without great effort and without difficult handholds. Furthermore, the predefined latching positions can also be used to save on installation space, since the tension bolts can be rotated/pivoted into a predetermined pivoted position in accordance with the available installation space and also remain there until they are actively pivoted out of the latching position. On account of the elastic variability of the relative position of the latching portion, the tension bolt can be pivoted out of the latching position with a definable additional force application, for example by gentle or a relatively large amount of manual pressure by an operator, such that free pivotability can be established again. Additional tools or complex handholds are not necessary for this operation.

The latching means is preferably a latching pin or a spring bolt. The fastening between the latching means and the tension bolt is preferably configured such that the latching means is screwed into an axial receiving bore, particularly preferably a threaded bore, introduced axially into one end of the tension bolt. The tensioning force of the spring bolt or of some other elastic body which holds the latching portion can be selected such that the tension bolt is held securely in latching engagement with the latching point and at the same time an additional (additional to the weight force of the tension bolt) predefined force moves the tension bolt out of the engaged position again.

Particularly preferably, the latching means can be fastened by, or have, a lock nut, with which the length by which the latching means or a section/latching portion of the latching means projects beyond the axial end of the tension bolt can be settable. Other possibilities for setting the length by which the latching means or a section of the latching means projects beyond the axial end of the tension bolt are, of course, also able to be used; for example washers or the like.

Preferably, a section/latching portion of the latching means projects in the basic state beyond the end of the tension bolt. If pressure or the like is then exerted on the latching means, the latter can be pushed in counter to an elastic resistance. When the pressure or the like is removed, the latching means or the latching portion/section of the latching means returns elastically into the basic state again. In order to push in the latching means or the section of the latching means, it is necessary for a predetermined pressure to be exceeded, this pressure preferably being selected or set, for example via the spring strength or the like, such that the latching means, when it is latched in a latching point, can hold at least the weight of the tension bolt. In other words, the latching connection between the latching means and a latching point is preferably not released again just by the weight of the tension bolt. This has the advantage that the latching connection can hold the tension bolt in a pivoted position and the latching connection is releasable by an additional (presettable) force application on the tension bolt.

Preferably, one nut per screw connection is fastened to the external thread of the tension bolt, said nut being able to retain the end of the tension bolt on which the nut is provided by means a force-fitting and/or form-fitting connection to a mobile vulcanizing press. Preferably, the underside of the nut can have a cut face formed in the form of a circular arc in the portion of the nut body in which a blind hole for receiving the external thread of the tension bolt is also arranged. The face of the nut formed in the form of a circular arc preferably serves to compensate torsional or flexural deflections of a lower or upper box of a mobile vulcanizing press during the vulcanization process.

Furthermore, the receiving bore of the latching means can preferably be embodied as a blind hole with an internal thread in a narrowed end portion of the bolt. The through-bore of the tension bolt can preferably be arranged in a bulbous portion of the bolt, which can particularly preferably (directly) adjoin the narrowed portion. The through-bore can preferably be provided to form a shaft-hub connection with corresponding components on the press body/lower or upper box. The shaping of the tension bolt with a narrowed and bulbous portions makes it possible to achieve an optimum compromise between weight reduction and mechanical strength.

A first and a second bolt receptacle, which are preferably disposed on the lower and upper boxes, can have different designs in order to allow optimum locking of the two boxes by means of the securing means. Thus, the first bolt receptacle serves preferably to allow the securing means to be mounted in a releasable and pivotable manner, while the second bolt receptacle preferably allows the clamping force between the two boxes to be set, in that a nut is screwed against a dished element of the second bolt receptacle (with the result that the spacing between the point at which the first bolt receptacle holds the securing means, and the point at which the second bolt receptacle holds the securing means). Furthermore, corresponding shaping of the dished element and of an underside of the nut preferably additionally results in bending and twisting movements of the vulcanizing press being compensated.

It is therefore possible for the mobile vulcanizing press to be easy to handle with as few additional tools as possible; for example, the securing means or the tension bolt can be removed from the vulcanizing press or fastened thereto without accessories, and the securing means or the tension bolt can be pivoted into different self-retaining pivoted positions and released therefrom again without further handholds/tools, in order to optimize the handling and the space requirement of the vulcanizing press. These points increase the handleability of the mobile vulcanizing press and reduce the space requirement both during construction and during operation, and so the vulcanizing press is tailored even better to the demands of mobile applications.

Furthermore, the mobile vulcanizing press can comprise at least one first bolt receptacle on the lower box (and/or the upper box, preferably the lower box), at least two first holding elements which are arranged in a manner spaced apart from one another, which can have openings arranged in an aligned manner, and between which the through-bore of the tension bolt can be arrangeable in a manner aligned with the openings in the holding elements in order to fasten said tension bolt in a pivotable manner to the lower or the upper box by way of a stub shaft. The at least one latching point or latching strip can be arranged between the holding elements. This arrangement of the holding elements and the latching point or latching strip allows a very compact construction of the mobile vulcanizing press, since the available installation space is used optimally.

Furthermore, the mobile vulcanizing press can have a plurality latching points, which define several pivoted positions of the tension bolt, wherein the latching points can be in the form of notches in a latching strip. The latching strip is a preferred possibility for providing latching points. However, it is also possible for toothed racks to be provided or notches which are provided directly in the housing of the box. The latching points are preferably arranged above and beneath one another along the vertical. The latching strip makes it possible, with little structural complexity, to provide several latching positions in predefined positions with as compact a construction as possible.

Furthermore, the mobile vulcanizing press can have, preferably on each of the upper and the lower box, a heating plate (also referred to as pressure plate in the following text), which can particularly preferably be heatable by means of integrated heating elements. The upper and the lower box can each have a rectangular footprint and the heating plate can have a parallelogram-shaped footprint in each case. The longitudinal edges of the heating plate and of the upper and lower boxes can be arranged one above another in a flush manner. The shorter (lateral) edges/transverse edges/transverse sides of the upper and lower boxes can protrude beyond the lateral edges of the heating plate. The at least one first bolt receptacle of the upper or lower box can be arranged in that portion of the lower or upper box that protrudes beyond the lateral edge of the heating plate. The abovementioned flush arrangement of the longitudinal edges makes it possible for no further components of the vulcanizing press to protrude at the longitudinal edges, and so the construction becomes even more compact and protruding components do not prevent a plurality of vulcanizing presses from being set up next to one another at their longitudinal edges, should this be necessary in the case of large pieces to be vulcanized. The shaping of the boxes and of the heating plates also makes it possible to provide, on each of the transverse sides of the boxes, a region/portion which can be provided for the installation/integration of the securing means/tension bolts and the receiving elements required therefor. There is thus likewise space for these components in the area of the rectangular footprint of the boxes, i.e. they do not protrude beyond the latter, thereby making the mobile vulcanizing press even more compact and thus even more suitable for mobile applications.

Furthermore, first holding elements can be in the form of metal plates which can preferably be arranged on the lower box. At least one second bolt receptacle, which comprises a dished element with a U-shaped cutout, can be arranged on the upper box. Furthermore, the dished element with a U-shaped cutout can be arranged on the upper box such that, when the tension bolt connected to the lower box is pivoted, said tension bolt is able to be brought into engagement with the U-shaped cutout, and wherein the dished element has a spherically recessed surface.

The shaping of the dished element and of the U-shaped cutout make it possible for the nut of the securing element to be able to be connected in a force-fitting and/or form-fitting manner with surface pressure there, such that the corresponding end of the securing element or of the bolt can be held securely by the second holding element. The fastening of the securing element to the boxes of the mobile vulcanizing press is allowed without further accessories/tools as a result and particularly easy to handle as a result.

Furthermore, the tension bolt can be securable in the first bolt receptacle by means of a stub shaft. The stub shaft can have a wing plate at one axial end, and the first bolt receptacle can have a wing receptacle. A portion of the wing plate of the stub shaft can be brought into engagement with the wing receptacle by means of rotation after the stub shaft has been plugged into the openings in the first holding elements of the first bolt receptacle. Furthermore, the wing plate can be a different color than the wing receptacle.

Securing by means of the stub shaft allows simple removal and fastening of the tension bolt from/to the box, such that, for example when there is little installation space, the securing means can be mounted only after the rest of the vulcanizing press has been constructed. Furthermore, it is possible to mount the mobile vulcanizing press and to secure the securing means and lock the boxes without accessories. The securing of the stub shaft can furthermore be visually checked very easily on account of the coloring.

Furthermore, the mobile vulcanizing press can have at least two securing means as described above, in order to be able to lock the upper box and the lower box together in the state arranged one on top of the other. Furthermore, the length of the securing means can be less than or equal to the spacing between a top side of the upper box and an underside of the lower box, such that no components or portions of components protrude beyond the box vertically, either.

In summary, the invention thus makes it possible to provide a mobile vulcanizing press which is easier to handle and more compact, such that it is suitable particularly for mobile applications, in which construction, reconstruction and deconstruction frequently take place and also there is frequently less installation space.

The invention is described by way of example in the following text with reference to the appended, schematic drawings, in which

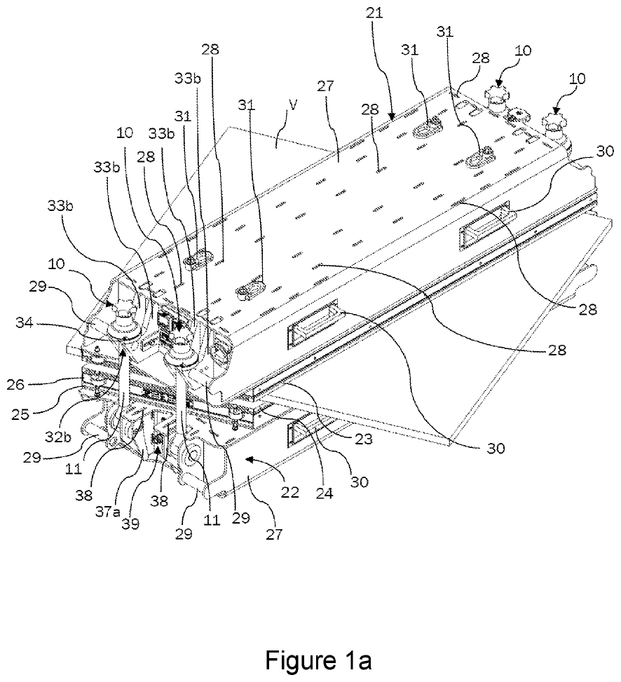

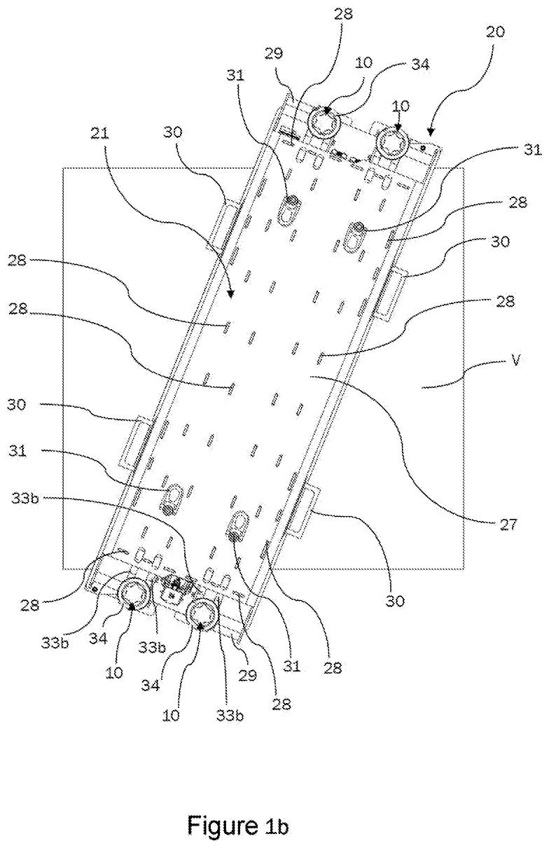

FIG. 1a shows a plan view of a mobile vulcanizing press with inserted material to be vulcanized,

FIG. 1b shows a perspective illustration of a mobile vulcanizing press with inserted material to be vulcanized,

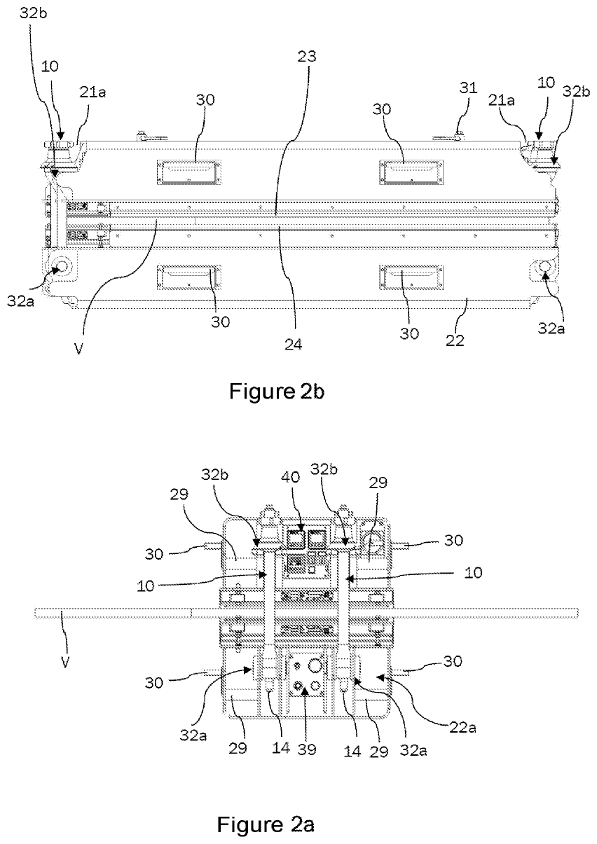

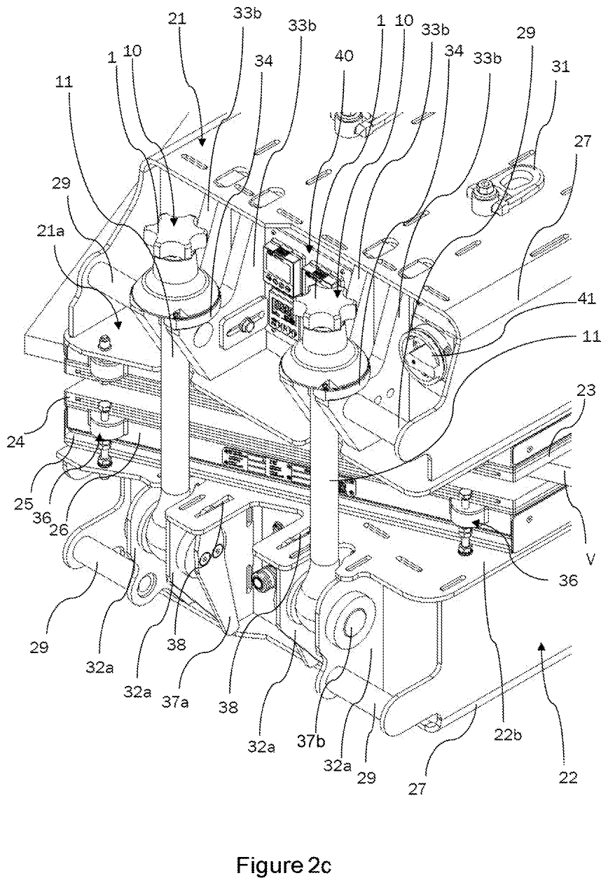

FIG. 2a shows a side view of a longitudinal side of a mobile vulcanizing press,

FIG. 2b shows a side view of a transverse side of a mobile vulcanizing press with inserted material to be vulcanized,

FIG. 2c shows an enlarged subsection of FIG. 1a,

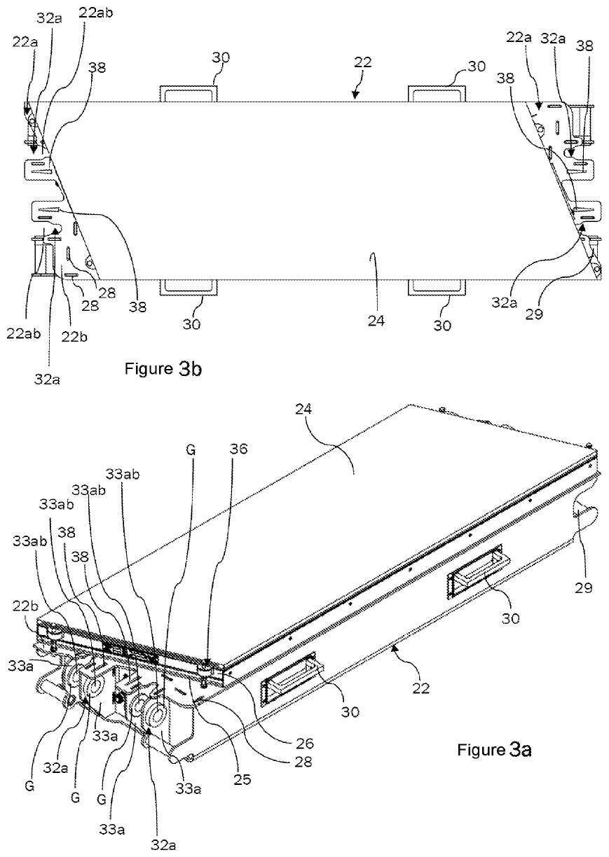

FIG. 3a shows a plan view of a lower box of a mobile vulcanizing press,

FIG. 3b shows a perspective view of a lower box of a mobile vulcanizing press,

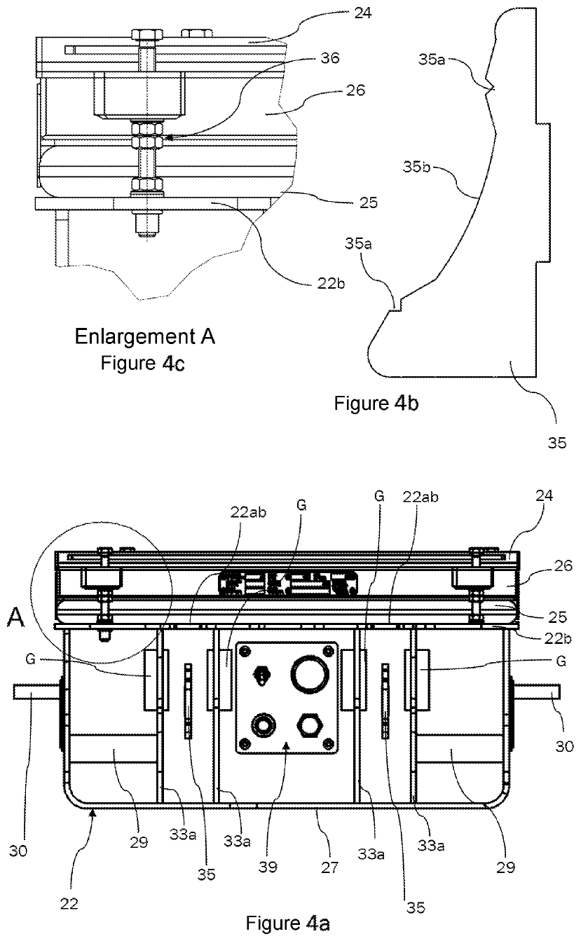

FIG. 4a shows a side view of a transverse side of a lower box of a mobile vulcanizing press,

FIG. 4b shows a detail view of a latching strip of a mobile vulcanizing press,

FIG. 4c shows an enlarged detail of the area A in the side view in FIG. 4a,

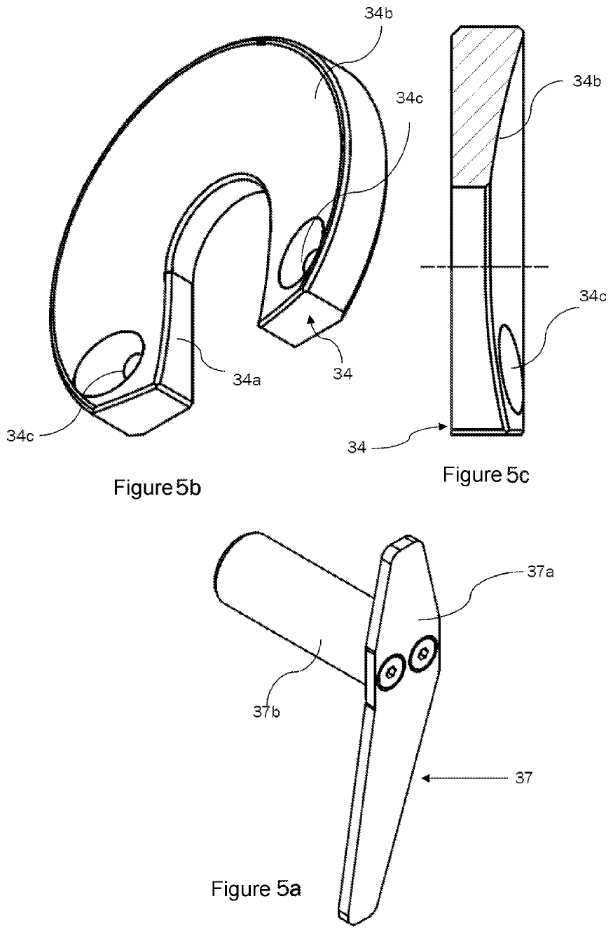

FIG. 5a shows a perspective view of a stub shaft of a mobile vulcanizing press,

FIG. 5b shows a perspective view of a dished element of a bolt receptacle of a mobile vulcanizing press,

FIG. 5c shows a sectional view of a dished element of a bolt receptacle of a mobile vulcanizing press,

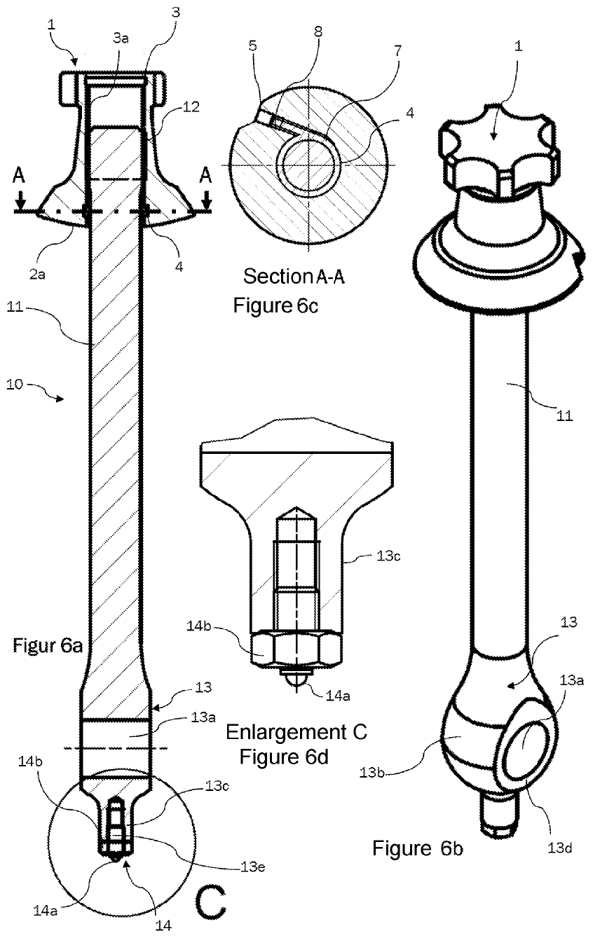

FIG. 6a shows a sectional view of a securing means for a mobile vulcanizing press,

FIG. 6b shows a perspective view of a securing means for a mobile vulcanizing press,

FIG. 6c shows an enlargement of the section A-A in FIG. 6a, and

FIG. 6d shows an enlarged detail of the area C in the sectional view in FIG. 6a.

In the following text, various examples of the present invention are described in detail with reference to the figures. Here, identical or similar elements in the figures are designated by identical reference signs. The present invention is not limited to the examples described, however, but also encompasses modifications of features of the described examples and combinations of features of various examples within the scope of protection of the independent claims.

FIGS. 1a and 1b show a perspective illustration and a plan view of a mobile vulcanizing press 20 with an upper box 21 and a lower box 22. The upper and the lower box (boxes) 21, 22 each have a heating plate 23, 24, which, when the mobile vulcanizing press 20 is mounted, is in contact with the material V to be vulcanized. These heating or pressure plates 23, 24 are preferably metallic and can particularly preferably be heated up (to a vulcanization temperature) by means of heating elements (not shown) or other heating components which can be installed in the two boxes 21, 22. In addition, at least one pressure pad 25 can be arranged in at least one of the two boxes 21, 22 or in both, and can be filled for example with air in order to be able to reduce or increase the pressure on the material V to be vulcanized. For example, the pressure pad 25 can be filled with compressed air or a water/glycol mixture. FIG. 4a shows, for example, such a pressure pad 25, which is installed in the lower box 22. Furthermore, an insulating layer 26, which can be manufactured for example from wood and preferably from several wood plies or laminates, can be provided, likewise optionally, between the heating plate 23, 24 and the pressure pad 25 or between the heating plate 23, 24 and further components which can be installed in the boxes 21, 22. This insulating layer 26 is provided particularly advantageously for the thermal insulation of the pressure pad 25 and for the thermal insulation of the other components of the box 21, 22.

Particularly preferably, both the upper and the lower box 21, 22 have a sheet-metal cover 27 which is preferably U-shaped in cross section and is connected by means of (a) weld(s) to mechanical reinforcements and frame parts of the corresponding box 21, 22 that are not shown in the figures. By way of the welding spots and points 28 (these are the dark elongate elements that are discernible, inter alia, on the top side of the upper box 21) in FIGS. 1a and 1b, it is possible to see that, for example, at least two longitudinal beams can extend as frame parts longitudinally through the upper box 21 (and similarly also through the lower box 22).

FIGS. 1a and 1b show further optional components, such as the handles 29 that are fastened to the two transverse edges of the boxes 21, 22 and are provided as round bars between two sheet-metal webs of each box 21, 22. Furthermore, the two figures also show folding handles 30 which are mounted on the longitudinal sides and fold in automatically (for example on account of a spring mechanism) when they are not being used, wherein the figures illustrate the folded-open state by way of example. The folding handles 30 are let into the side walls of the boxes 21, 22, such that, in the folded-in state, the folding handles 30 disappear completely in the side wall and end flush with the longitudinal edge of the box 21, 22. This has the technical advantage that, in the mounted state of the mobile vulcanizing press 20, in which the folding handles 30 are folded in, no components protrude beyond the longitudinal edge of the two boxes 21, 22, and so it is also possible for a plurality of the mobile vulcanizing presses 20 to be arranged alongside one another at their longitudinal sides; for example when relatively large material V to be vulcanized is intended to be processed.

Furthermore, optional lifting eyes 31 can be arranged at least on the top side of the upper box 21, said lifting eyes 31 being particularly preferably screwed into the upper box 21, such that the lifting eyes 31 can be removed at any time. The lifting eyes 31 can be used to lift the upper box 21 or the entire mobile vulcanizing press 20 by means of a crane or of a crane hook. In use, the lifting eyes 31 can be removed in order to reduce the overall height of the mobile vulcanizing press, in particular in that then no components protrude beyond the upper or lower surface of the upper and lower box 21, 22.

Furthermore, FIGS. 1a and 1b, and particularly clearly also FIG. 3b, show that the two boxes 21, 22 each have a rectangular footprint and the pressure plates 23, 24 are each parallelogram-shaped and arranged centrally within this rectangular footprint (illustrated in FIG. 3b, inter alia). It is furthermore apparent that the sheet-metal cover 27 is not present/does not extend in each case along the entire length of the rectangular box footprint, and so the respective longitudinal-direction end portions (side edges or transverse edges) of the two boxes 21, 22 are open, or not covered by the sheet-metal cover 27. In the open end portion of the upper and of the lower box 21, 22, both the optional handles 29 and bolt receptacles 32a, 32b, which will be explained in detail below, are arranged, inter alia.

FIGS. 2a and 2b show both the first and the second bolt receptacles 32a and 32b, respectively. First bolt receptacles 32a, which are mounted on the lower box 22 in the example shown, are particularly clearly apparent in FIGS. 3a and 3b. FIGS. 2a and 2b, and also FIG. 1a show a mounted state of the mobile vulcanizing press 20, in which the two boxes 21, 22 are arranged one on top of the other in an aligned manner, material V to be vulcanized has been inserted between the heating plates 23, 24, and the two boxes 21, 22 have been locked or secured together in position by means of four securing means 10 (fewer or more are also possible), which have been inserted into the bolt receptacles 32a, 32b.

FIG. 1a shows that in each case two second bolt receptacles 32b are provided on the upper box 21 in the region of that portion 22a of the upper box 21 that is not covered by the sheet-metal cover 27, said second bolt receptacles 32b each comprising two second holding elements 33b that are arranged parallel to one another and each hold a dished element 34 shown in FIGS. 5b and 5c. In the locked state of the mobile vulcanizing press 20, the tension bolts 11 are pivoted such that they are each in engagement with a U-shaped cutout 34a in the dished element 34 of the associated second bolt receptacles 32b. The nut 1 of the securing means 10 is furthermore screwed together with the external thread 12 of the bolt 11; specifically such that a lower surface 2a of the nut 1 (FIG. 6) rests on the surface of a partially spherical recess 34b in the dished element 34. The dished elements 34 are connected to the second holding element 33b via drilled holes 34c and screws. In this case, it should be noted that the second holding elements 33b are preferably substantially L-shaped, such that the shorter of the two legs of the imaginary L can carry the dished element 34. The longer leg of the imaginary L is connected to a side wall of the upper box 21.

FIG. 2a moreover shows the optional feature of the mobile vulcanizing press 20, whereby a control panel 40 can be integrated into one of the two boxes 21, 22, said control panel 40 being able to be arranged within the box 21, 22 by means of a separate housing (not shown). The housing seals the control panel 40 and the electric components installed therein from penetrating moisture. The control panel can have in particular electric components such as heating regulators for the two boxes 21, 22, and one or more displays and switch elements, with which the operation of the mobile vulcanizing press 20 can be set and controlled. Furthermore, a circuit breaker 41, for example in the form of a rotary switch, can preferably be provided on the top box 22. Furthermore, one of the boxes 21, 22 can have a media connection 39 for compressed air and/or hydraulic fluid and the like, which can likewise be entirely integrated into the box 21, 22. The integration of these control and operating means into the boxes 21, 22 makes the mobile vulcanizing press 20 even more compact, since no external control boxes or the like are necessary.

FIGS. 3a and 3b show by way of example the structure of the lower box 22. In principle, it is clarified here that, with regard to the components and functions, set out in this description, of the upper and the lower box, these can also be reversed, such that, for example, the first bolt receptacles 32a are mounted on the upper box 21 and the tension bolts 11 are held in a pivotable manner on the upper box. The explanations here therefore serve in particular to illustrate the technical basic principle and, to this end, a distribution, shown in the figures, of the components and functions between the upper box 21 and the lower box 22 is assumed.

Attention should be paid, in the two FIGS. 3a and 3b, in particular to the portion 22a that is not covered by the cover plate 27 and has, in addition to the optional handles 29, in particular (preferably two) first bolt receptacles 32a. These have at least two first holding elements 33a, which are preferably flat plates and are arranged parallel to and spaced apart from one another. The first holding elements 33a each have an opening/bore 33ab, wherein the openings 33ab in the two holding elements 33a, arranged spaced apart from one another, of the first bolt receptacles 32a are arranged in a manner aligned with one another, such that a stub shaft 37 can be received. The openings 33ab are preferably round, such that a round stub shaft 37 can be plugged in, which can receive a round through-bore 13a of a tension bolt 11 in order to mount the tension bolt 11 in a pivotable manner (see also FIG. 2c). Optionally, plain bearings G can also be inserted into the opening 33ab. A preferably metal intermediate plate 22b of the lower box is arranged in a vertical direction between the first holding elements 32a and the pressure plate 24. This intermediate plate 22b can be cut out between the two first holding elements 32a (cut-out region 22ab), in order to not (excessively) limit the pivoting range of a tension bolt 11 (see FIG. 1a) mounted between the first holding elements 32a.

FIG. 4a shows an enlarged cross-sectional view of the lower box 22, which shows the above-described first holding elements 33a and also the plain bearings G and the arrangement of the first holding elements 33a of a first bolt receptacle 32a with respect to one another. Furthermore, it is apparent from FIG. 4a that, between the two first holding elements 33a, a latching strip 35 is arranged, which is illustrated in side view in FIG. 4b. In the present example, the latching strip 35 has two latching points 35a, in which a latching means 14 that is yet to be described, or a latching portion 14a of the latching means 14, can latch when the tension bolt 11 held in a pivotable manner by the first bolt receptacles 32a is pivoted. The distance between the axial end of the tension bolt 11, including the latching means 14, and the latching points 35a, is in this case dimensioned such that the latching means 14 can also actually engage. Readjustment of the length of the tension bolt 11, including the latching means 14, is optionally provided for example via a possibility described in conjunction with FIG. 6, for example a lock nut.

Preferably, the latching strip 35 also has an arcuate cutout 35b between the latching points 35a, such that no contact occurs between the latching means 14 and the latching strip 35a in the region of the arcuate cutout 35b when the tension bolt 11 is pivoted. Furthermore, it should be noted that the number of latching points 35a can also be one or more than two. This is dependent in particular on how many predefined pivoted positions of the tension bolt 11 are intended to be provided. Thus, in the present example of the latching strip 35 according to FIG. 4b, a horizontal pivoted position of the tension bolt 11 and a central pivoted position (between the horizontal and the vertical) are provided. In these two pivoted positions, the securing means 10 or the tension bolt 11 can be held in the pivoted position on account of the latching force between the latching means 14 and the latching points 35a.

An advantage of the provision of predefined locked pivoted positions is that the tension bolts 11/securing means 10 do not have to be additionally held during the mounting of the mobile vulcanizing press 20, thereby making construction easier. Furthermore, different lockable pivoted positions can be set without additional components or handholds. This is advantageous when, for example, the available space at the point of use of the mobile vulcanizing press is limited, since it is then possible for example to select a central pivoted position (an angle position between the horizontal and the vertical) and thus the length by which the securing means 10 protrude beyond the sides of the lower box 22 can be shortened, thereby considerably reducing the space requirement of the mobile vulcanizing press 20, in particular during construction. This thus improves the mobile properties of the vulcanizing press and makes it usable in a more versatile manner.

Moreover, FIG. 4c shows the enlargement A from FIG. 4a, wherein an adjusting-screw connection 36 is provided, which allows fine adjustment, inter alia and in particular, of a distance between the pressure plate 24 and the pressure pad 25.

Finally, FIG. 5a shows a stub shaft 37 with a wing plate 37a, which is connected perpendicularly to an axis of the shaft 37b; for example via a screw connection shown in FIG. 5a. The wing plate 37a has a shorter and a longer portion proceeding from the connecting region between the wing plate 37a and shaft 37b. The shorter region is provided for bringing same into engagement with a wing receptacle 38, which tapers in an arrow-shaped or triangular manner and is arranged in the upper plate 22b of the lower box 22 as a recess laterally to the first bolt receptacle 32a. This makes it possible that, when the tension bolt 11 is arranged with its through-bore 13a (FIG. 6) between the two first holding elements 33a, the shaft 37b of the stub shaft 37 can be plugged through the openings 33ab and the through-bore 13a, such that the tension bolt 11 is held in a pivotable manner on the lower box 22.

Securing of the stub shaft 37 in order to prevent the shaft 37b from sliding axially out of the opening 33ab and/or the through-bore 13a can be prevented by traction on the longer portion of the wing plate 37a, such that the shorter portion of the wing plate 37b in engagement with the wing receptacle 38 can be rotated. The rotation can be continued until sufficient frictional contact between the wing receptacle 38 and a part of the wing plate 37a has been established, which prevents automatic releasing of the frictional connection. On account of the engagement produced in this way between the wing plate 37a and the wing receptacle 38 in the upper plate 22b, the stub shaft 37 is reliably prevented from falling out. FIG. 1a and the enlargement in FIG. 2c show this secured state. If the wing plate 37a is additionally optionally designed with a different color than the upper plate 22b, an indication of securing that is quickly discernible visually can be realized.

The low-complexity mounting of the securing means 10 or of the tension bolt 11 by means of the stub shaft 37, which can be carried out without further tools or other accessories, advantageously makes it possible for the securing means 10 or the tension bolt 11 to be able to be removed entirely from the box 21 at any time without great effort, in particular if this is necessary for space reasons for example during the construction or deconstruction of the mobile vulcanizing press 20.

With regard to the overall height, a further advantage of the mobile vulcanizing press that needs to be specified is that, on account of the arrangement and design of the first and second tension-bolt receptacles 32a,b—for example they are let into the uncovered portions 21a, 22a of the boxes 21, 22—the securing means 10 do not protrude beyond the upper edges or lower edges of the boxes 21, 22, entailing a further reduction in the overall size and ensuring the mobility of the vulcanizing press to an even greater extent.

FIG. 6a shows a securing means 10 having a nut 1 and a tension bolt 11. One end or end portion of the tension bolt 11 is screwed into a blind hole 3 in the nut 1. To this end, the blind hole 3 has an internal thread 3a and the tension bolt 11 has an external thread 12 on the corresponding end portion. The tension bolt is preferably made of high-strength steel or high-strength aluminum.

A fixing element 7 keeps a longitudinal portion of the tension bolt 11 captively connected to the nut 1. This longitudinal portion preferably directly adjoins the external thread 12. The fixing element 7 is arranged in the groove 4 and an access bore 5 that is visible in FIG. 6c. The fixing element 7 shown in FIG. 6c has a rectangular cross section and can protrude partially out of the groove 4 and into the blind hole 3 or have the same cross section as the groove 4. The access bore 5 and the groove 4 can preferably have the same cross-sectional area size. It is noted that the fixing element 7 can also have other cross-sectional shapes, for example a round or oval shape. The fixing element 7, which extends in the groove 4, forms a loop which can be placed around a longitudinal portion of the tension bolt 11. This loop keeps the nut 1 connected securely and captively to the tension bolt 11.

FIG. 6a also shows a preferred outer shaping of the nut 1, which, or the body of which, has been optimized in terms of as low a weight as possible and shape-related compensation of bending and twisting movements of the mobile vulcanizing press. Preferably, the surface 2a, as illustrated in FIG. 6a, is embodied in the form of a circular arc, in order to be able to form optimal contact with the associated surface 34b of the dished element 34 according to FIG. 5b. This shaping of the surface 2a and of the face of the dished element 34 allows the compensation of possibly occurring deformations of the mobile vulcanizing press 20 during operation, which can arise in particular as elastic torsional or warping deformations. Furthermore, the shape of the nut 1, as is also illustrated very clearly in FIG. 6b, is formed in as material-saving a manner as possible, and in particular the lateral surface is greatly narrowed, and an upper portion (opposite the surface 2a) is embodied in a star-shaped manner, this having a weight-saving effect and also allowing good handling of the nut 1, in particular during screwing.

Furthermore, the section A-A according to FIG. 6c shows details of the nut 1 with regard to the access bore 5, the arrangement of the fixing element 7 within the groove 4 and the access bore 5, and with regard to a fastening means 8 which can be connected to the fixing element 7. The fastening means 8 has an external thread which is in contact with an internal thread of the through-bore 5 and allows adjustment of the relative position of the fastening means 8 within the through-bore 5. Particularly preferably, the fixing element 7 is pushed into the access bore 5 during initial mounting. Then, the fastening means 8, for example a screw, can be screwed into the access bore 5. As a result of the fastening means 8 being screwed in, the fixing element 7 is pushed into its end position, in which the fixing element 7 forms a loop around the tension bolt 11 and can secure the tension bolt 11 captively to the nut 1 as a result. If the position of the fastening means 8 is intended to be prevented from being subsequently changed again, the position of the fastening means 8 in the access bore 5 can finally be fixed with an adhesive.

As an alternative to the above-described example, the fastening means 8 can for example also be a sleeve with an external thread, which has a receptacle for fastening one end of the fixing element 7. The fixing element 7 can be firmly connected to the fastening means 8 for example by means of an adhesive bond or a clamping connection.

The section A-A in FIG. 6c shows the arrangement of the fastening means 8 and of the fixing element 7 in the through-bore 5 and in the groove 4, respectively, after the fastening means 8 has been rotated into its predetermined position. The fixing element 7 extends as far as its opposite end around the groove 4, such that a loop is formed. The loop engages around the diameter of the blind hole 3. The other end of the fixing element 7 (i.e. the end which is not arranged at the fastening means 8) can be fixed within the groove 4 by means for example of a force-fitting or form-fitting connection. For example, the groove 4 can have a narrowing, in which the end of the fixing element 7 can be clamped. Furthermore, the groove 4 can have a spike (not shown), which spikes the fixing element 7 at its end and thus retains the latter. A materially-bonded connection can be realized for example by means of an adhesive bond.

According to the alternative example in which the fastening means 8 and one end of the fixing element 7 are firmly connected together, the fastening means 8 can be rotated outward in the direction of the an opening of the access bore 5. Since the opposite end of the fixing element 7 can be fixed in the groove 4, the fixing element 7 can be stretched and the diameter of the loop of the fixing element 7 reduced. This constriction of the loop can be used, in the case of a tension bolt 11 screwed into the blind hole 3, to arrange the fixing element 7 even more tightly around the tension bolt 11, thereby retaining the nut 1 even more securely. Deeper screwing of the fastening means 8 into the access bore 5 can release the securing of the tension bolt 11 again, in that the loop is expanded. In addition, the fixing element 7 can prevent penetration of particles of dirt and dust.

Furthermore, FIG. 6a shows the opposite axial end from the external thread 12 of the tension bolt 11, or the end portion 13 thereof. This end portion, which is shown here by way of example, has a bulbous portion 13b, into which a through-bore 13a has been let. The longitudinal axis of the through-bore 13a is preferably arranged perpendicularly to the longitudinal axis of the tension bolt 11. The outer faces 13d of the bulbous portion 13b are flat, such that these outer faces 13d can be in or be brought into sliding contact with the holding elements of the tension-bolt receptacle, should this be necessary for space reasons.

Furthermore, the bulbous portion 13b is adjoined by a narrowed portion 13c of the tension bolt 11, which has at its axial end a receiving bore 13e in which a latching means 14 is arranged, in particular has been screwed in. The latching means 14 is preferably a spring bolt or some other component which has a latching portion 14a that is elastically displaceable or is elastically variable in position. The latching portions 14a, or the latching means 14, can be pushed in the direction of the tension bolt 11 by means of a predetermined force, for example one that exceeds the spring force or the like of the latching means 14, such that the latching means 14 projects less or no longer projects at all beyond the axial end of the tension bolt 11. In an unloaded basic state, by contrast, the latching means 14, or the latching portion 14a thereof, projects beyond the end of the tension bolt 11, as is shown in FIGS. 6a and 6d.

Furthermore, the latching means 14 can also comprise a lock nut 14b, which allows the axial relative position of the latching means 14, or of the latching portion 14a thereof, to be set. In other words, the optional lock nut 14b allows the length by which the latching portion 14a, or the latching means 14, projects beyond the end of the tension bolt 11 to be able to be adjusted or set at any time.

As already described above, the through-bore 13a in the tension bolt 11 serves to be passed through by the stub shaft 37 in order to arrange the tension bolt 11 in a pivotable manner on one of the boxes 21, 22 (what is shown is the case: lower box 21). Furthermore, the latching means 14 is arranged at the end of the tension bolt 11 such that at least the latching portion 14a engages with the latching points 35a of the latching strip 35 when the tension bolt 11 is held in a pivotable manner by the first tension-bolt receptacle 32a.

In summary, the invention therefore allows a mobile vulcanizing press to be provided which is easier to handle and is more compact, such that it is suitable particularly for mobile applications, in which construction, reconstruction or deconstruction frequently takes place and also there is frequently little installation space. Specific technical advantages can be in particular that the tension bolt(s) 11 can be pivotable and in particular latchable and can also be removed with little complexity, inter alia on account of the tension bolt axis, which can be a stub shaft 37 and can be locked securely in its entirety. Furthermore, the tension bolts 11 can be produced from high-strength aluminum and have a low weight. The thread 12 thereof can be protected from damage particularly well and be sealed off from contamination, since the nut 1 can have the above-described fixing and sealing means 7.

Further technical advantages are that the upper ends of the tension bolts or of the nuts 1 of the securing elements 10 can end flush with the top side of the vulcanizing press 20 on account of the let-in tension-bolt nut receptacle 32b. The low design achieved in this way creates versatile setup possibilities, inter alia also in environments with little installation space. It is also possible for two vulcanizing presses 20 to be positioned alongside one another without problems, since no lateral components protrude which would first of all have to be dismantled/removed. The preferred foldable side handles 30 contribute toward the low overall size in a lateral direction and at the same time allow comfortable handling. The preferred lifting eyes 31 ensure safe crane operation and are removable with little effort.

The vulcanizing press 20 can also have a fully functional, compact control panel 40 with an appropriate housing, and can be integrated fully into the vulcanizing press 20 or one of the boxes 21, 22. The control panel 40 can be fitted out comprehensively, inter alia with one or more digital temperature regulators, one or more displays of the setpoint/actual temperature of the heating plates 23, 24, one or more displays of the setpoint/actual value of the vulcanization time, one or more temperature-difference monitor(s), one or more reset buttons, which may or may not be equipped with a light, and the like. In addition, even in manual operation of the vulcanizing press 20, the greatest possible safety can be ensured, inter alia a touch switch can be provided for automatic operation and/or a thermometer bore in the heating plates 23, 24 for the use of a digital thermometer during manual operation.

1. A securing means for a mobile vulcanizing press, having
a tension bolt, which has an external thread at one of its two axial ends, and at its opposite axial end a latching means is arranged, wherein
the tension bolt has a through-bore, which is arranged between the two axial ends of the tension bolt and the axis of which is arranged perpendicularly to that of the tension bolt, and wherein
a length by which the latching means projects beyond the axial end of the tension bolt is elastically variable.

2. A mobile vulcanizing press, having
a lower box and an upper box which are arrangeable one on top of the other with material to be vulcanized in between, wherein
the lower box has at least one first bolt receptacle on which a tension bolt is arrangeable in a pivotable manner, and wherein
at least one latching point is arranged on the lower box such that a latching means of a tension bolt can latch in the at least one latching point in at least one predetermined pivoted position of the tension bolt.

3. The mobile vulcanizing press as claimed in claim 2, wherein the at least one first bolt receptacle comprises at least two first holding elements which are arranged in a manner spaced apart from one another, which have openings arranged in an aligned manner, and between which the through-bore of the tension bolt is arrangeable in a manner aligned with the openings in the holding elements in order to fasten the tension bolt in a pivotable manner to the lower or the upper box by way of a stub shaft, and wherein
the at least one latching point is arranged between the first holding elements.

4. The mobile vulcanizing press as claimed in claim 2, wherein a plurality of latching points are provided, which define several pivoted positions of the tension bolt, wherein the latching points are in the form of notches in a latching strip.

5. The mobile vulcanizing press as claimed in claim 2, wherein the upper and the lower box each have a heating plate, wherein the upper and the lower box have a rectangular footprint and the heating plate has a parallelogram-shaped footprint in each case, wherein
the longitudinal edges of the heating plate and of the upper and lower boxes are arranged one above another in a flush manner and the shorter lateral edges of the upper and lower boxes protrude beyond the lateral edges of the heating plate, and wherein
the at least one first bolt receptacle of the upper or lower box is arranged in that portion of the lower or upper box that protrudes beyond the lateral edge of the heating plate.

6. The mobile vulcanizing press as claimed in claim 2, wherein the holding elements are in the form of metal plates which are arranged on the lower box, and at least one second bolt receptacle, which comprises a dished element with a U-shaped cutout is arranged on the upper box.

7. The mobile vulcanizing press as claimed in claim 2, wherein a dished element with a U-shaped cutout is arranged on the upper box such that, when the tension bolt connected to the lower box is pivoted, the tension bolt is able to be brought into engagement with the U-shaped cutout, and wherein
the dished element has a spherically recessed surface.

8. The mobile vulcanizing press as claimed in claim 2, wherein the tension bolt is securable in the first bolt receptacle by means of a stub shaft, which has a wing plate at one axial end, and the first bolt receptacle has a wing receptacle, which is suitable for bringing a portion of the wing plate of the stub shaft into engagement with the wing receptacle by means of rotation after the stub shaft has been plugged into the openings in the first holding elements of the first bolt receptacle.

9. The mobile vulcanizing press as claimed in claim 8, wherein the wing receptacle is a different color than the wing plate.

10. The mobile vulcanizing press as claimed in claim 2, wherein
at least two securing means for connecting the upper box and the lower box in the state arranged one on top of the other, the means having:
a tension bolt, which has an external thread at one of its two axial ends, and at its opposite axial end a latching means is arranged, wherein
the tension bolt has a through-bore, which is arranged between the two axial ends of the tension bolt and the axis of which is arranged perpendicularly to that of the tension bolt, and wherein
a length by which the latching means projects beyond the axial end of the tension bolt is elastically variable.

11. The mobile vulcanizing press as claimed in claim 10, wherein the length of the securing means is less than or equal to the spacing between a top side of the upper box and an underside of the lower box.
